(19) United States
(12) Patent Application Publication
(10) Pub. No.: US 2005/0052744 A1
(43) Pub. Date: Mar. 10, 2005

(54) Method of fabricating a fine optical grating element stamper

(75) Inventor: Kuo-Chi Chiu, Hsinchu (TW)

Correspondence Address: Welsh & Katz, Ltd.;Eric D. Cohen, 22nd Floor, 120 South Riverside Plaza, Chicago, IL, 60606, US

(73) Assignee: Industrial Technology Research Institute, Hsinchu (TW)

(21) Appl. No.: 10/970,443

(22) Filed: Oct. 21, 2004

(30) Foreign Application Priority Data
Aug. 8, 2003 (TW) 93123229

(51) Int. Cl. G11B 5/58

(52) U.S. Cl. 359/566

(57) ABSTRACT

A method for fabricating an optical grating element stamper is disclosed. The method is modified from the fabrication process of a read-only optical disc to form a stamper with an optical grating element structure. The method features that a photoresist layer on a substrate is exposed to a light source, the light source moves along a plurality of concentric circles from inner circle to outer circle and intermittently exposes the photoresist layer to form an optical grating pattern on the substrate.

### BACKGROUND OF THE INVENTION

1. Field of the Invention

The invention relates to a method for fabricating an optical grating element stamper. In particular, it relates to a method for fabricating a precise optical grating element stamper through a similar fabrication process of read-only optical disc. In addition, the signal of the optical grating element fabricated by using the stamper can be read through a common optical pick-up head.

2. Related Art

An optical encoder, whose resolution is determined by the grating scale of an optical grating element, is composed of an optical grating element and an optical reading device. A finer grating scale gives a higher resolution. Optical encoders are widely used for detecting angles, speed or positions in many precise control systems.

Conventionally, optical grating elements used in optical encoders are made by plastic mold-injection, machining or a semiconductor process.

The optical grating elements made by the plastic mold-injection are easy and low cost, while their fine grating scale is limited by the precision of mold and injection. Therefore, they cannot meet the high-resolution requirements to be used in the precise control systems.

The optical grating elements made by machining are also limited to the precision of machining and the fine grating scale of optical grating elements can not be obtained. As a result, they cannot be used in the high-precision control systems either. Further, machining is not optimal for mass production and it's expensive.

The semiconductor process for making the optical grating elements is illustrated in FIGS. 1A to 1I.

First, in FIG. 1A, a glass or metal substrate 1 is provided with a flat surface after polishing. Then, the surface is cleaned to be free from dusts.

In FIG. 1B, a photoresist layer 2 is coated on the surface of the substrate 1, then, heated and cured there, as shown in FIG. 1C, through a curing process.

Then, in FIG. ID, using a photo mask 3, which carries an optical grating pattern, on the substrate 1 to expose and transfer the optical grating pattern onto the surface of the substrate 1 after developing, as shown in FIG. 1E. FIG. 1F shows the cross-section view of the substrate 1 developed.

Further, in FIG. 1G, depositing a metallic film 4 on the surface of the substrate 1 as a reflective layer through a sputtering or evaporating process. The reflective layer makes the optical grating pattern readable by light beam. FIG. 1H shows the cross-section view of the substrate 1 having the reflective layer. Then, coating a protective layer 5 on the substrate 1 to protect the optical grating element, as shown in FIG. 1I.

Though the aforesaid semiconductor process can produce the optical grating element with fine grating scales to meet high-resolution requirements, the optical signal is weak. Therefore, a highly precise optical reading device is necessary for reading the weak signal. The delicate structure makes the product expensive and inconvenient for mass production. Moreover, the optical signal is weak and sensitive to vibration, which usually causes reading failure. In order to read the weak signal of the optical grating element, a complicated optical reading device including lens, mirrors and prisms, etc., as disclosed in U.S. Pat. No. 4,829,342 and U.S. Pat. No. 4,868,385, is required. However, it's very expensive and is difficult in alignment and sensitive to vibration.

### SUMMARY OF THE INVENTION

The object of the invention is to provide a new method for fabricating an optical grating element stamper. The method is modified from the fabrication process of a read-only optical disc. The optical grating elements fabricated by using the stamper have fine grating scales suitable for being used in the high-resolution control systems and they possess vibration resistance.

The stamper can be used as a mold for the plastic injection so that optical grating elements can be easily made through the mold-injection and deposition process. Mass production is possible and costs less. Further, the optical grating element made from the stamper has very fine patterns similar to that made by using a semiconductor process and gives high resolution. Besides, the weak signal from the optical grating element can be easily read using a common optical pick-up head. The common optical pick-up head is reliable and resistant to vibration to meet the requirements of high-precision control systems and to overcome the problems of prior arts.

A comparison among fabrication processes for mold-injection, machining, semiconductor and a read-only optical disc process for optical grating elements is listed as follows.

| Characteristics | | Reso- | | Mass | Reading |
|---|---|---|---|---|---|
| Different process | Process | lution | Price | production | device |
| Plastic mold-injection | Easy | Low | Low | Easy | Simple |
| Machining | Easy | Low | High | Difficult | Simple |
| Semiconductor process | Difficult | High | Ex- | Difficult | Com- |
| | | | pensive | | plicated |
| Read-only optical disc | Easy | High | Low | Easy | Simple |
| process | | | | | |

From the table, it is clear that the optical grating element made by using the read-only optical disc process of the invention has an easy process, high resolution, low price, and easy for mass production. The optical reading device is simple and reliable.

The prior arts of making a read-only optical disc include the following steps. First, polishing a glass substrate to get a flat surface. Washing and removing dusts from the surface of the substrate. Then, coating a photoresist layer on the surface of the substrate. Heating and curing the photoresist layer. Further, using a high power laser to write data patterns to make a data spiral track on the substrate. Forming the data patterns on the substrate through a developing process. Then, depositing a metallic film as an electrically conductive layer on the substrate through a sputtering or evaporating process. Further, electroplating the substrate to increase the thickness of the metallic film and forming a metallic plate. Then, the metallic plate is separated from the substrate. The metallic plate carries the reversed patterns of the data patterns on the substrate. Cleaning the metallic plate, polishing its back, punching the central hole and removing the circumference excessive portion to accomplish a stamper for making the read-only optical disc.

When making a read-only optical disc, the stamper is used as a mold for plastic injection and getting a plastic substrate that has a corresponding pattern to that of the stamper. Then, the plastic substrate is coated with a metallic film as a reflective layer so that a laser beam can read the data patterns from the optical disc. Finally, a protective layer is formed on the optical disc to finish a common read-only optical disc. The fabrication process is inexpensive because the plastic mold-injection is easy and suitable for mass production.

The fabrication process of the invention is similar to that of making a read-only optical disc. In the exposure process, the fabrication process of a read-only optical disc uses a high power laser to write data patterns to make a data spiral track on the substrate. The invention features an additional high frequency pulse generator for controlling the rotational speed of a motor and the switch of the laser writing. Because the substrate is placed upon the motor, controlling the rotational speed of the motor also means controlling that of the substrate. In the exposure process, the light source moves along a plurality of concentric circles from inner circle to outer circle and intermittently exposes the photoresist layer to form an optical grating pattern on the substrate precisely. After a developing process, an optical grating element pattern is formed on the photoresist layer.

Then, a metallic film as an electrically conductive layer is deposited on the substrate. Further, the substrate is electroplated to increase the thickness of the metallic film and form a metallic plate. Finally, the metallic plate is separated from the substrate. The metallic plate carries a reversed pattern of the optical grating pattern on the substrate. Finally, an optical grating element stamper is accomplished through the rest procedures as described above for making a stamper of a read-only optical disc.

When making an optical grating element, the stamper is used as a mold for plastic injection and getting a plastic substrate that has a correspondent pattern to that of the stamper. Then, the plastic substrate is coated with a metallic film as a reflective layer so that a laser beam can read the data pattern from the optical disc. Finally, a protective layer is formed on the optical disc to finish an optical grating element.

The invention uses the well-developed fabrication process for making a stamper of a read-only optical disc with an additional high frequency pulse generator. The method is to control the light source moving along a plurality of concentric circles from inner circle to outer circle and intermittently exposing the photoresist layer to form an optical grating pattern on the substrate. So, the fabrication process for making the stamper of a read-only optical disc can be continued using to make the fine optical grating element stamper.

The optical grating element made by the invention has fine grating scales for being used in the precise control systems. Though the optical signals are weak, they can be read using a common optical pick-up head, so that no special or complicated reading device is needed. The common optical pick-up heads are adequate for reading the weak signals of the optical grating element accordingly and they are reliable and low-cost.

Moreover, the focal lens in the optical pick-up head can be finely adjusted by using an actuator when the focus of reading is not well aligned. The fine adjustment helps the optical grating element free from poor signal problems caused by an uneven surface or vibration. Therefore, using the optical pick-up head is the only way to avoid the vibration problem of prior arts.

The optical grating element made by using the read-only optical disc fabrication process of the invention has fine grating scales suitable for optical encoders and meets the high-resolution requirements of precise measuring systems. Common inexpensive and practical optical pick-up heads can be used for reading the weak signals of the optical grating element. The optical grating element is also applicable to a sliding mechanism and used as a control element of precise displacement.

### BRIEF DESCRIPTION OF THE DRAWINGS

The invention will become more fully understood from the detailed description given hereinbelow. However, this description is for purposes of illustration only, and thus is not limitative of the invention, wherein:

FIGS. 1A to 1I are sequential views of a semiconductor fabrication process for making an optical grating element;

FIGS. 2A to 2Q are sequential views of a modified read-only optical disc fabrication process for fabricating a stamper of an optical grating element;

FIGS. 3A to 3E are sequential views of a fabrication process of mold-injection and film-deposition for fabricating an optical grating element from a stamper made by using the process of the invention; and

FIGS. 4A to 4D are sequential views of a fabrication process of mold-injection, film-deposition and adhesion for fabricating an optical grating element from a stamper made by using the process of the invention.

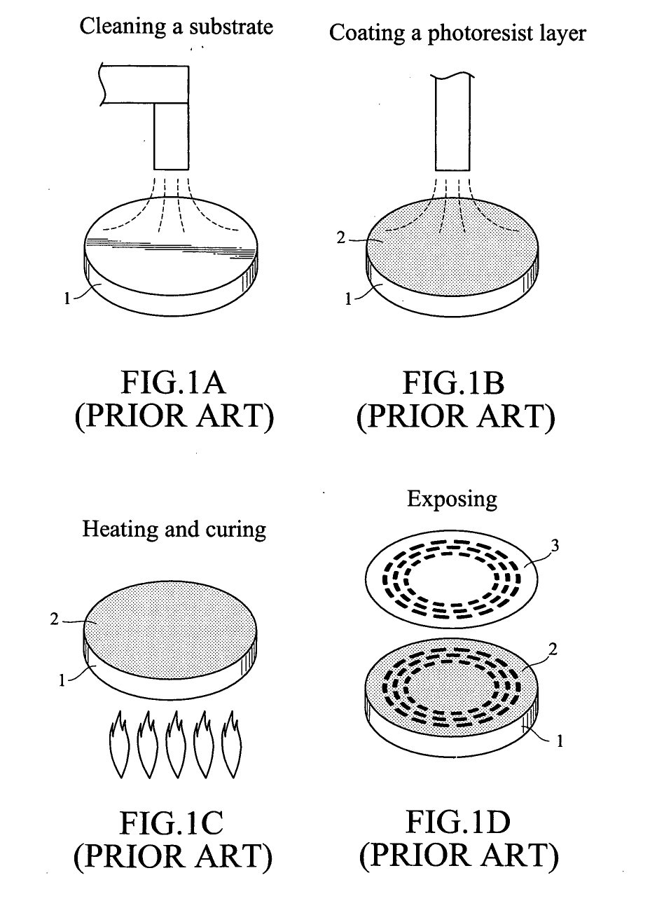

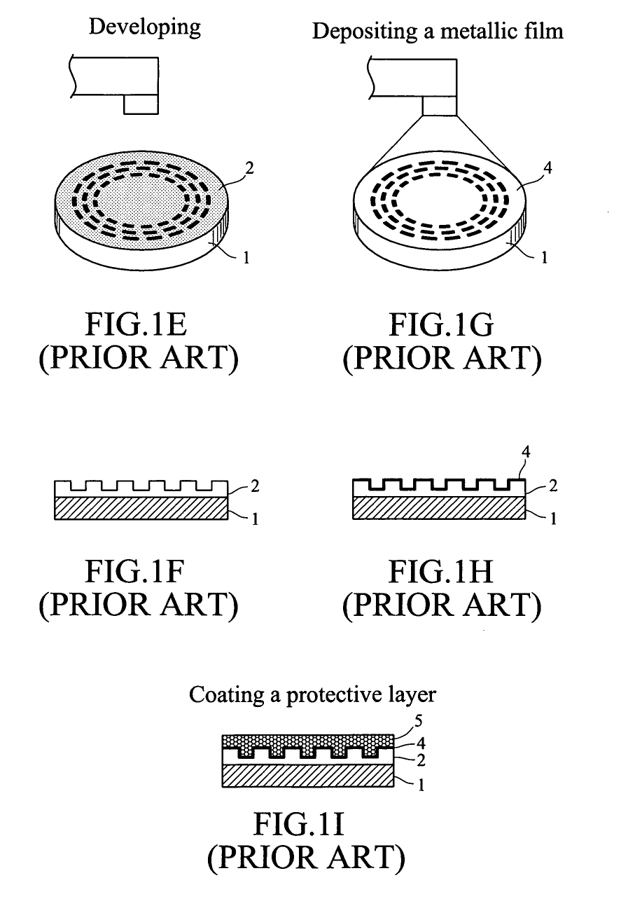

### DETAILED DESCRIPTION OF THE INVENTION

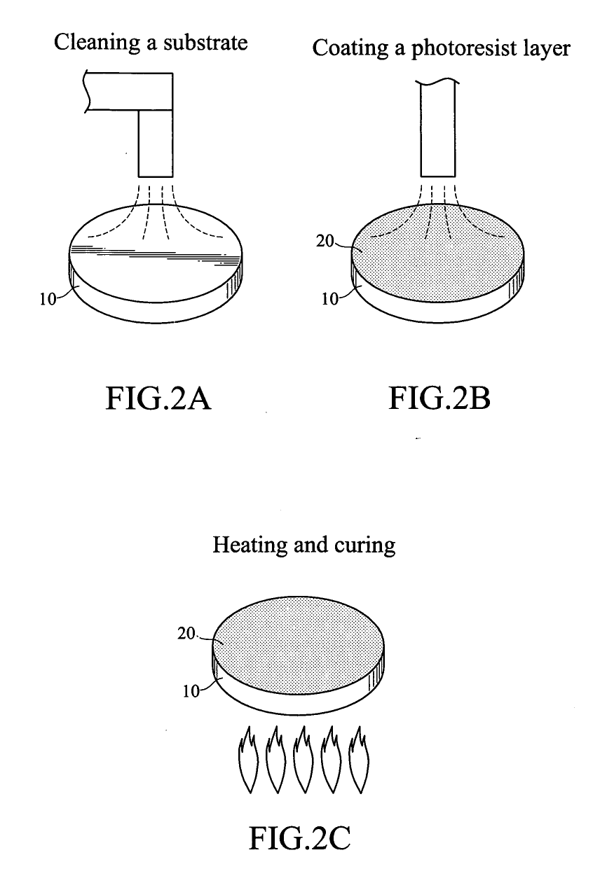

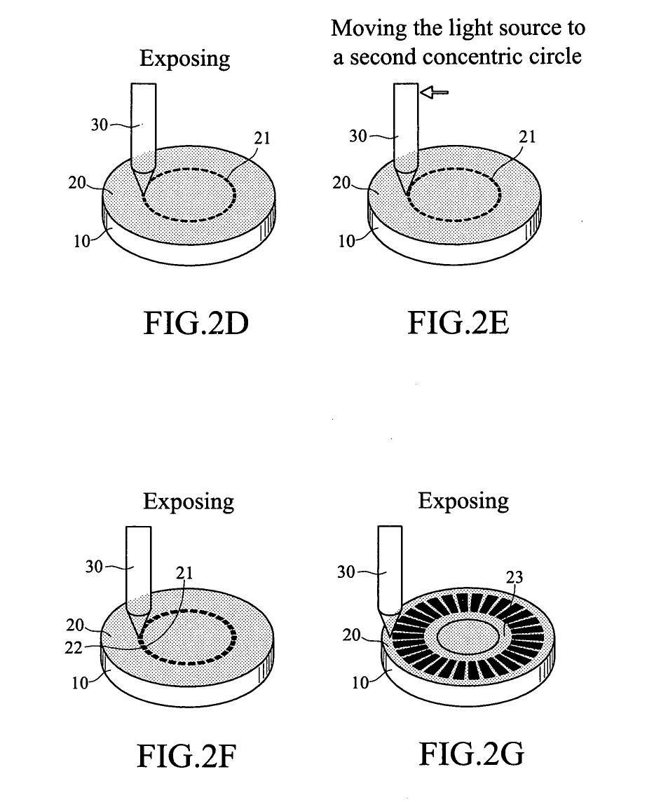

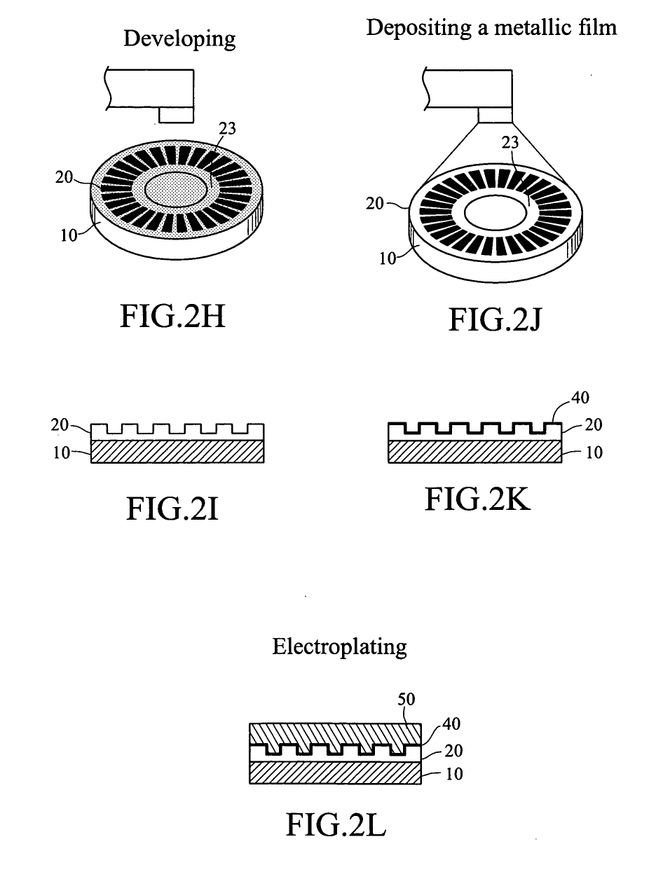

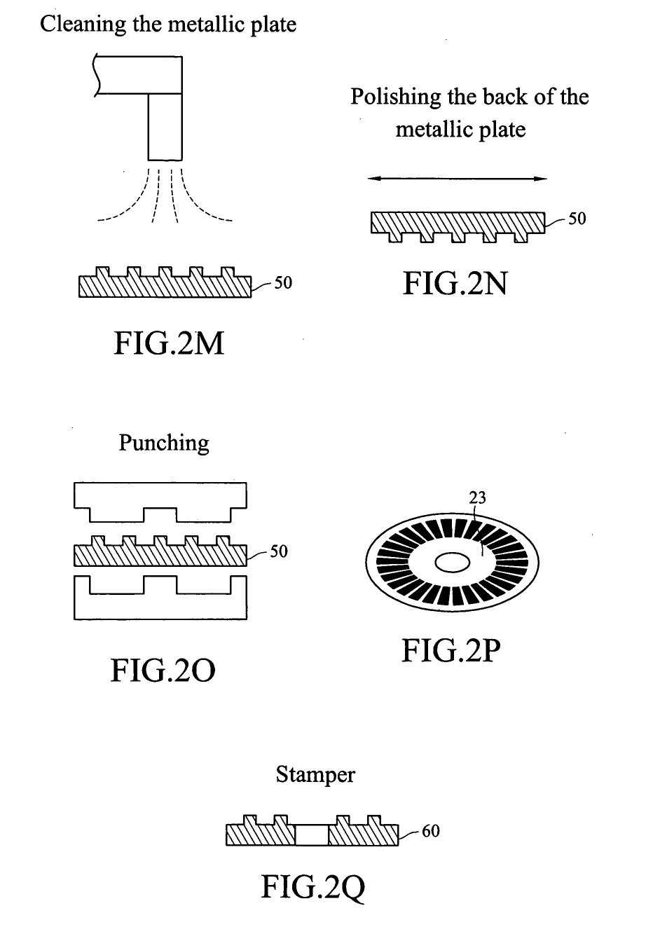

FIGS. 2A to 2Q are sequential views of a modified read-only optical disc fabrication process of the invention for fabricating a fine optical grating element stamper.

First, in FIG. 2A, polishing a substrate 10 to get a flat surface. Washing the substrate 10 for removing dusts on the surface of the substrate 10. The material of the substrate 10 is glass. Then, in FIG. 2B, spin-coating a photoresist layer 20 on the surface of the substrate 10. After that, heating and curing the photoresist layer 20 on the substrate 10, as shown in FIG. 2C.

Then, a light source 30 (usually a laser beam) moves along a plurality of concentric circles from inner circle to outer circle and intermittently exposes the photoresist layer 20 to form an optical grating pattern on the substrate 10. As shown in FIG. 2D, the exposure time and positions of the light source 30 are controlled to expose a plurality of first exposure spots 21 around a first concentric circle, having a first radius on the photoresist layer 20. The first exposure spots 21 are spaced apart from each other by a predetermined distance.

When the light source 30 completes exposing at the first concentric circle, the light source 30 moves outward to a second concentric circle, having a second radius as shown in FIG. 2E. The second radius is slightly larger than the first radius as shown in FIG. 2D.

Then, please refer to FIG. 2F, exposing a plurality of second exposure spots 22 around a second concentric circle, having the second radius on the photoresist layer 20 by controlling the exposure time and positions of the light source 30. Each of the first exposure spots 21 is connected with the second exposure spot 22, respectively.

Next, the light source 30 moves along a plurality of concentric circles from inner circle to outer circle and exposes the photoresist layer 20 to form the optical grating pattern on the substrate 10 as shown in FIG. 2G. The exposure spots at the adjacent concentric circles should be connected with each other and aligned.

Because the light source 30 moves along a plurality of concentric circles from inner circle to outer circle, the operation time of the light source 30 is different at different concentric circles. Besides, the light source 30 can move along a plurality of concentric circles from inner circle to outer circle or from outer circle to inner circle. Just make sure that each of the exposure spots is connected and aligned with another one at the adjacent concentric circles, respectively.

The optical grating pattern on the substrate 10 as shown in FIG. 2G has a single grating scale, so that an optical grating element made from it has a fixed fine grating scale. Users can control the exposure time and positions of the light source 30 to form an optical grating pattern, having multiple grating scales on the same substrate 10. Users can choose the different grating scale regions for different needs and expand the applications of an optical encoder.

In the optical grating pattern on the photoresist layer 20, there is a circular reflective region 23 at the center of the patterns. The reflective region 23 has no optical grating patterns but a plane for checking the performance of the laser diode in the optical pick-up head. When the laser diode decays, the reflection from the reflective region 23 decreases and indicates that the laser diode has to be replaced. Therefore, there is no need to use additional components for calibration of the laser source. The reflective region 23 is not necessary at the center portion. It can be located at the circumference, for example.

The shape, resolution and other characteristics of the optical grating element stamper made by the invention are decided by the exposure time and positions of the light source 30. In FIG. 2H, an optical grating pattern on the substrate 10 is formed through a developing process and an excessive photoresist layer 20 is removed. In FIG. 2I, a cross-section of the optical grating pattern is shown.

Then, in FIG. 2J, a metallic (usually nickel) film 40 as an electrically conductive layer is deposited on the substrate 10 through a sputtering or evaporating process. FIG. 2K shows the cross-section view of the substrate 10 having the metallic film 40. Further, in FIG. 2L, the substrate 10 is electroplated to increase the thickness of the metallic film 40 and a metallic plate 50 is formed. This is also a cross-section view of the metallic plate 50. The thickness of the metallic plate 50 is between 0.2 mm and 0.4 mm.

Then, in FIG. 2M, the metallic plate 50 is separated from the substrate 10. The metallic plate 50 carries a reversed pattern of the optical grating pattern on the substrate 10. Further, in FIG. 2N, the metallic plate 50 is cleaned, its back is polished, the central hole is punched and the circumference excessive portion is removed, as shown in FIG. 20, to finish a stamper 60, as shown in FIG. 2P, for making the optical grating elements. FIG. 2Q shows the cross-section view of the stamper 60.

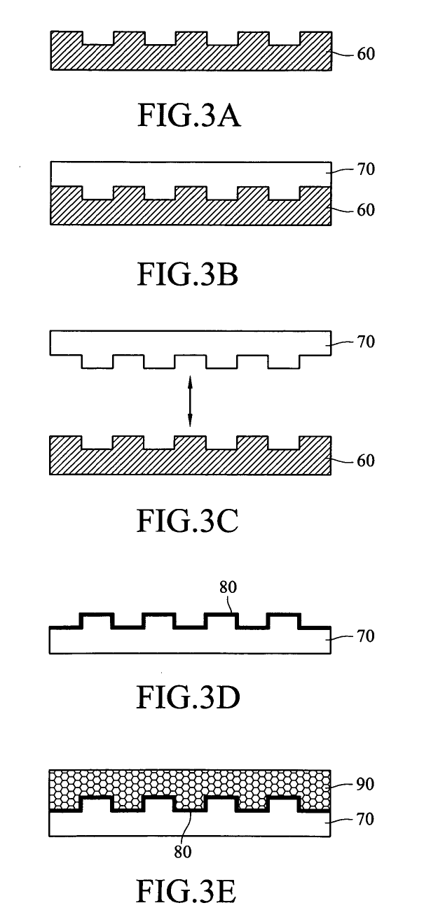

FIGS. 3A to 3E are sequential views of a fabrication process of mold-injection and film-deposition for making an optical grating element from a stamper made by using the process of the invention.

As shown in FIG. 3A, when making an optical grating element, the stamper 60 is used as a mold for the plastic injection and getting a plastic substrate 70 as shown in FIG. 3B. The plastic substrate 70 is made of a polycarbonate with a thickness of 0.6 mm to 5 mm. Then, in FIG. 3C, the plastic substrate 70, having a correspondent pattern to that of the stamper 60, is separated from the stamper 60. In FIG. 3D, the plastic substrate 70 is coated with a metallic film 80 as a reflective layer so that a laser beam can read the data signals from the plastic substrate 70. The metallic film 80 is usually made of aluminum, having a reflectivity over 35%. Finally, in FIG. 3E, a protective layer 90 is formed through spinning coating on the metallic film 80, to finish an optical grating element. The material of the protective layer 90 is an acrylic photocurable resin.

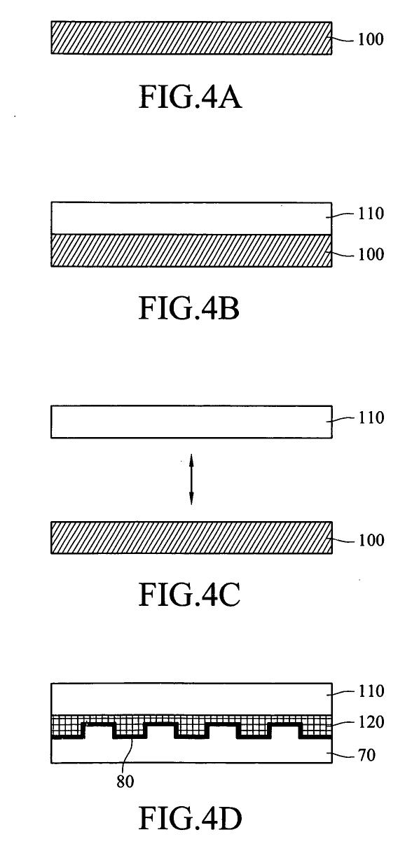

As shown in FIGS. 4A to 4D, the optical grating element can also be made by adhesion. First, in FIG. 4A, a blank stamper 100 is made by using a similar process of the aforesaid read-only optical disc fabrication process. Then, in FIG. 4B, the blank stamper 100 is used as a mold for the plastic injection and gets a plastic blank substrate 110. The blank substrate 110 is made of a polycarbonate with the thickness of 0.6 mm to 5 mm. Then, in FIG. 4C, the blank substrate 110 is separated from the blank stamper 100. In FIG. 4D, the blank substrate 110 is adhered to a plastic substrate 70 with a metallic film 80 made from the aforesaid process of FIG. 3D and then the optical grating element is finished. The optical grating element made by adhesion is stronger than that made with a protective layer through spinning coating.

While the optical grating element of the invention is made through the read-only optical disc fabrication process, the weak signals of the optical grating element can be read using a common optical pick-up head. In comparison with the complicated optical reading system composed of lenses, mirrors, prisms, etc., for reading the fine grating scale in prior arts, the common optical pick-up head is adequate for optical grating elements of the invention in reading data and it is practical, inexpensive and convenient.

Moreover, the focal lens in the optical pick-up head can be finely adjusted by using an actuator when the focus of reading is not well aligned. The fine adjustment helps the grating element free from poor signal problems caused by an uneven surface or vibration. Therefore, using a common optical pick-up head is the only way to avoid the vibration problem of prior arts.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of fabricating a fine optical grating element stamper, comprising following steps of:
providing a substrate;
coating a photoresist layer on a surface of said substrate;
heating and curing said photoresist layer on said substrate;
exposing said photoresist layer by a light source moving along a plurality of concentric circles from inner circle to outer circle and intermittently exposing said photoresist layer to form an optical grating pattern on said substrate;
developing said substrate to remove a part of said photoresist layer to form an optical grating pattern on said substrate;
depositing a metallic film on said substrate as an electrically conductive layer for electroplating;
electroplating said substrate to increase the thickness of said metallic film and forming a metallic plate; and
separating said metallic plate from said substrate; said metallic plate is a stamper with a reversed pattern of said optical grating pattern on said substrate.

2. The method of fabricating a fine optical grating element stamper according to claim 1, wherein said step of exposing said photoresist layer by the light source further comprises the following steps of:
forming a plurality of first exposure spots, spaced apart from each other by a predetermined distance, around a first concentric circle, having a first radius on the photoresist layer by controlling the exposure time and positions of the light source;
moving the light source to a second concentric circle, having a second radius slightly larger than the first radius;
forming a plurality of second exposure spots, respectively; connected to the first exposure spots, around the second concentric circle, having the second radius by controlling the exposure time and positions of the light source; and
moving the light source along a plurality of concentric circles from inner circle to outer circle and exposing the photoresist layer to form the optical grating pattern on the substrate.

3. The method of fabricating a fine optical grating element stamper according to claim 1 wherein material of said substrate is glass.

4. The method of fabricating a fine optical grating element stamper according to claim 1 wherein said optical grating pattern comprises a plane reflective region for forming a laser source checking region on said optical grating element.

5. The method of fabricating a fine optical grating element stamper according to claim 1 wherein said optical grating pattern has a single grating scale so as to form said grating element with a fixed fine grating scale.

6. The method of fabricating a fine optical grating element stamper according to claim 1 wherein said optical grating pattern has multiple grating scales so as to form said optical grating element with multiple grating scales.

7. The method of fabricating a fine optical grating element stamper according to claim 1 wherein said step of depositing a metallic film on said substrate is through sputtering.

8. The method of fabricating a fine optical grating element stamper according to claim 1 wherein said step of depositing a metallic film on said substrate is through evaporating.

9. The method of fabricating a fine optical grating element stamper according to claim 1 wherein the material of said metallic film is nickel.

10. The method of fabricating a fine optical grating element stamper according to claim 1 wherein said metallic plate with a reversed pattern of said optical grating pattern has a thickness around 0.2 mm to 0.4 mm.
